(19) United States
(12) Patent Application Publication
(10) Pub. No.: US 2009/0235357 A1
(43) Pub. Date: Sep. 17, 2009

(54) Method and System for Generating a Malware Sequence File

(75) Inventors: Timothy D. Ebringer, Richmond (AU); Hamish O'Dea, Ashburton (AU); Trevor Douglas Yann, Rowville (AU); Kelsey Molenkamp, Glen Iris (AU)

Correspondence Address: BAKER BOTTS L.L.P., 2001 ROSS AVENUE, SUITE 600, DALLAS, TX, 75201-2980, US

(73) Assignee: Computer Associates Think, Inc., Islandia, NY (US)

(21) Appl. No.: 12/048,595

(22) Filed: Mar. 14, 2008

(51) Int. Cl. G06F 21/00; G06F 11/30

(52) U.S. Cl. 726/24

(57) ABSTRACT

The present disclosure is directed to a method and system for generating a malware sequence file. In accordance with a particular embodiment of the present disclosure, a malware sequence file is generated by identifying a common sequence among files. Identifying a common sequence among the files includes comparing at least a first file and at least a second file to identify a first output sequence. Identifying a common sequence among the files also includes comparing at least a third file and the first output sequence to identify a second output sequence.

### TECHNICAL FIELD

The present disclosure relates generally to computer security, and more particularly to a method and system for generating a malware sequence file.

### BACKGROUND

Computer security has become increasingly more important, particularly in order to protect against malware. Malware generally refers to any malicious computer program. For example, malware may include viruses, worms, spyware, adware, rootkits, and other damaging programs.

Malware may impair a computer system in many ways, such as disabling devices, corrupting files, transmitting potentially sensitive data to another location, or causing the computer system to crash. In addition, malware may conceal itself from software designed to protect a computer, such as antivirus software. For example, malware may infect components of a computer operating system and thereby filter the information provided to antivirus software.

### SUMMARY

In accordance with the present invention, the disadvantages and problems associated with previous techniques for generating a malware sequence file may be reduced or eliminated.

In accordance with a particular embodiment of the present disclosure, a method includes generating a malware sequence file by identifying a common sequence among a plurality of files. Identifying a common sequence among the plurality of files includes comparing at least a first file of the plurality of files and a second file of the plurality of files to identify a first output sequence. Identifying a common sequence among the plurality of files also includes comparing at least a third file of the plurality of files and the first output sequence to identify at least a second output sequence.

Technical advantages of particular embodiments of the present disclosure include a system and method for generating a malware sequence file that may generate a generic malware sequence. For example, malware may include common components. A generic malware sequence may identify entire families of malware.

Further technical advantages of particular embodiments of the present disclosure include a system and method for generating a malware sequence file where the file is generated by identifying longest common subsequences. For example, previous methods for generating malware sequence files may be inefficient. By iteratively comparing sample malware files to identify the longest common subsequence, the system may efficiently generate the malware sequence file.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a block diagram illustrating a system for generating a malware sequence file, according to the teachings of the present disclosure;

FIG. 2A is a block diagram illustrating the sequence generator of the system of FIG. 1 generating an output sequence, according to one embodiment of the present disclosure;

FIG. 2B is a block diagram illustrating the sequence generator of the system of FIG. 1 generating another output sequence, according to one embodiment of the present disclosure;

FIG. 2C is a block diagram illustrating the sequence generator of the system of FIG. 1 generating a malware sequence file, according to one embodiment of the present disclosure;

FIG. 3A is a block diagram illustrating the sequence generator of the system of FIG. 1 generating a sequence based on a longest common subsequence, according to one embodiment of the present disclosure;

FIG. 3B is a block diagram illustrating the sequence generator of the system of FIG. 1 generating another sequence based on a longest common subsequence, according to one embodiment of the present disclosure; and

FIG. 4 is a flow diagram illustrating a method for generating a malware sequence file, according to one embodiment of the present disclosure.

### DESCRIPTION OF EXAMPLE EMBODIMENTS

A common defense against malware, such as computer viruses and worms, is antivirus software. Antivirus software identifies malware by matching patterns within data to what is referred to as a “signature” of the malware. Typically, antivirus software scans for malware signatures. However, generating malware signature files may be a difficult and time-consuming process.

Malware signature files may be generated based on a common sequence in malware sample files. For example, a common sequence may be identified by comparing malware sample files and identifying one or more longest common subsequences in the malware sample files. The longest common subsequence refers to a maximum length sequence of two or more strings. A string may include a string of bytes, a string of characters, or any other suitable string. However, the longest common subsequence is different from the longest common substring. The longest common substring is contiguous, while the longest common subsequence may not be contiguous. For example, for the input strings “abxyab” and “abab,” the longest common subsequence is “abab,” but the longest common substring is only “ab.”

Comparing binary files to identify longest common subsequences is a computationally complex process because binary files may include large numbers of bytes. Therefore, comparing binary files to identify the longest common subsequences of bytes requires large amounts of computing resources. Thus, comparisons to identify longest common subsequences are often reserved for comparisons of strings of characters (e.g., text files).

In accordance with the teachings of the present disclosure, two malware sample files are compared to identify at least one longest common subsequence. An output sequence based on the longest common subsequence is generated. The output sequence is compared with another malware sample file to identify another longest common subsequence. There may be many iterations of the comparison described above. For example, there may be at least one iteration for each malware sample file provided. As these iterations take place, the length of the output sequence drops and dissimilar code in the malware sample files is removed. After comparing each of the malware sample files to the output sequence, a malware sequence file is generated based on the identified common sequence. Thus, the method and system of the present disclosure generate a malware sequence file for protection against malware. Additional details of example embodiments of the present disclosure are described in detail below.

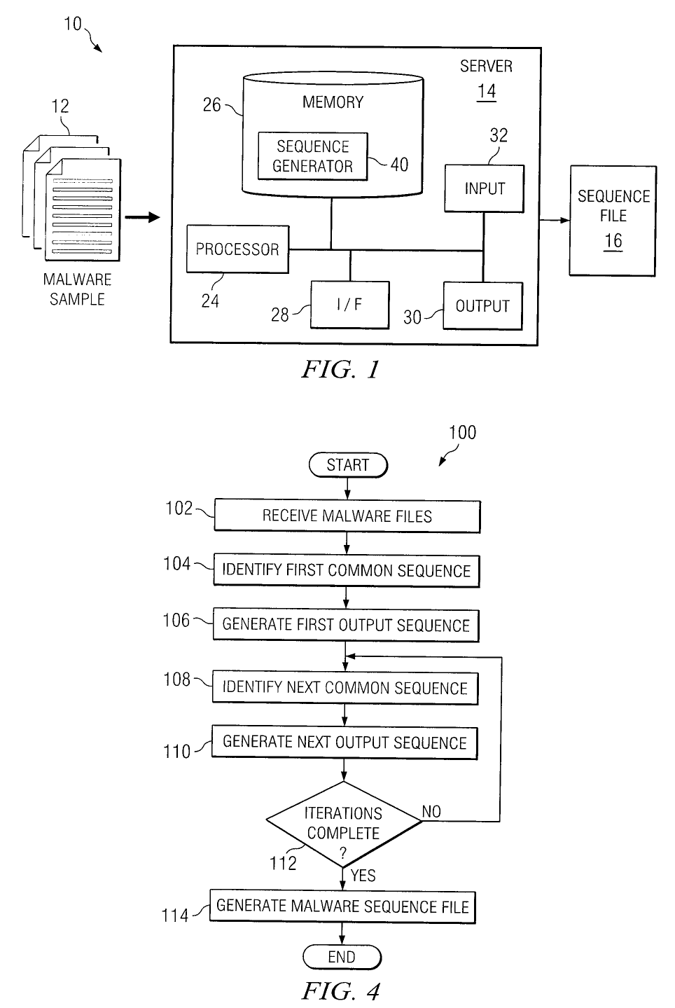

FIG. 1 is a block diagram illustrating a system 10 for generating a malware sequence file, according to the teachings of the present disclosure. System 10 generally includes one or more malware sample files 12, a server 14, and a malware sequence file 16. According to the embodiment, server 14 may receive malware sample files 12 and may generate a malware sequence file 16 based on malware sample files 12.

Malware sample file 12 may refer to any suitable data stored at server 14. For example, malware sample file 12 may be a file that includes a malware sample. The malware sample may include a characteristic malware sequence. Malware sample file 12 may include a memory dump. Malware sample file 12 may include an executable file. An executable file, also referred to as a binary file, refers to data in a format that a processor may execute. Malware sample file 12 may also include other data formats, such as a dynamic link library file, a data file, or any other suitable file that may be include a malware sample.

Server 14 may refer to any suitable device operable to generate malware sequence file 16. Examples of server 14 may include a host computer, workstation, web server, file server, a personal computer such as a laptop, or any other device operable to receive malware sample files 12. Server 14 may include any operating system such as MS-DOS, PC-DOS, MAC-OS, WINDOWS, UNIX, OpenVMS, or other appropriate operating systems, including future operating systems.

In particular embodiments, the malware in malware sample files 12 may infect clients. Once malware infects a client, the malware may damage expensive computer hardware, destroy valuable data, or compromise the security of sensitive information. Malware may spread quickly and infect networks connected to the client.

According to one embodiment of the disclosure, a sequence generator 40 may generate malware sequence file 16 to detect malware before it may infect clients and networks. This is effected, in one embodiment, by receiving malware sample files 12 at sequence generator 40. Sequence generator 40 may iterate over malware sample files 12 to identify a common sequence among malware files 12. Sequence generator 40 may compare at least a first file of malware sample files 12 and a second file of malware sample files 12 to identify a first sequence. In particular embodiments, sequence generator 40 may identify the first sequence by identifying at least one longest common subsequence. Sequence generator 40 may generate at least a first output sequence based on the first sequence. Sequence generator 40 may compare at least a third file of the plurality of files and the first output sequence to identify a second sequence. In particular embodiments, sequence generator 40 may identify the second sequence by identifying at least one longest common subsequence. Sequence generator 40 may generate a malware sequence file for the plurality of files based on the common sequence.

In particular embodiments, sequence generator 40 may generate malware sequence file 16 based on common components in malware sample files 12. For example, as sequence generator 40 iterates over malware sample files 12, the output sequence may stabilize, and dissimilar components may be removed, thereby generating a generic malware sequence file 16. The generic malware sequence file 16 may be particularly useful in identifying entire families of malware.

In particular embodiments, sequence generator 40 may generate malware sequence file 16 that identifies a new malware component. For example, as sequence generator 40 iterates over malware sample files 12, comparing the files to a characteristic malware sequence, if the length of the output sequence drops, the drop may be indicative of a previously unidentified malware component. Thus, if the length of the output sequence drops significantly, malware sequence file 16 may be particularly useful in identifying new malware.

In particular embodiments, sequence generator 40 may optimize the generation of malware sequence file 16. For example, sequence generator 40 may identify bytes indicative of zero in the plurality of files. In particular embodiments, sequence generator 40 may remove the bytes as the files are being read by sequence generator 40. In particular embodiments, sequence generator 40 may remove the plurality of bytes in the output sequence after the comparison.

In particular embodiments, sequence generator 40 may reduce the number of false positive matches generated by the comparison of malware sample files 12. For example, sequence generator 40 may define a spatial limit in which matches may occur. Therefore, sequence generator 40 may perform a comparison to identify a longest common subsequence, however sequence generator 40 may limit the space to identify the longest common subsequence to within 200 bytes, as an example. Defining a limit in which matches may occur may reduce the number of false positive matches in malware sequence file 16.

In particular embodiments, sequence generator 40 may facilitate searching of malware sequence file 16. For example, sequence generator 40 may receive input from a user to search for a particular search string in malware sequence file 16. If sequence generator 40 locates the search string in malware sequence file 16, sequence generator 40 may generate an output for the user identifying the location of the search string. Additional details of the other components of server 14 are described below.

Processor 24 may refer to any suitable device operable to execute instructions and manipulate data to perform operations for server 14. Processor 24 may include, for example, any type of central processing unit (CPU).

Memory device 26 may refer to any suitable device operable to store and facilitate retrieval of data, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

Communication interface (I/F) 28 may refer to any suitable device operable to receive input, send output, perform suitable processing of the input or output or both, communicate to other devices, or any combination of the preceding. Communication interface 28 may include appropriate hardware (e.g. modem, network interface card, etc.) and software, including protocol conversion and data processing capabilities, to communicate through a LAN, WAN, or other communication system that allows server 14 to communicate to other devices. Communication interface 28 may include one or more ports, conversion software, or both.

Output device 30 may refer to any suitable device operable for displaying information to a user. Output device 30 may include, for example, a video display, a printer, a plotter, or other suitable output device.

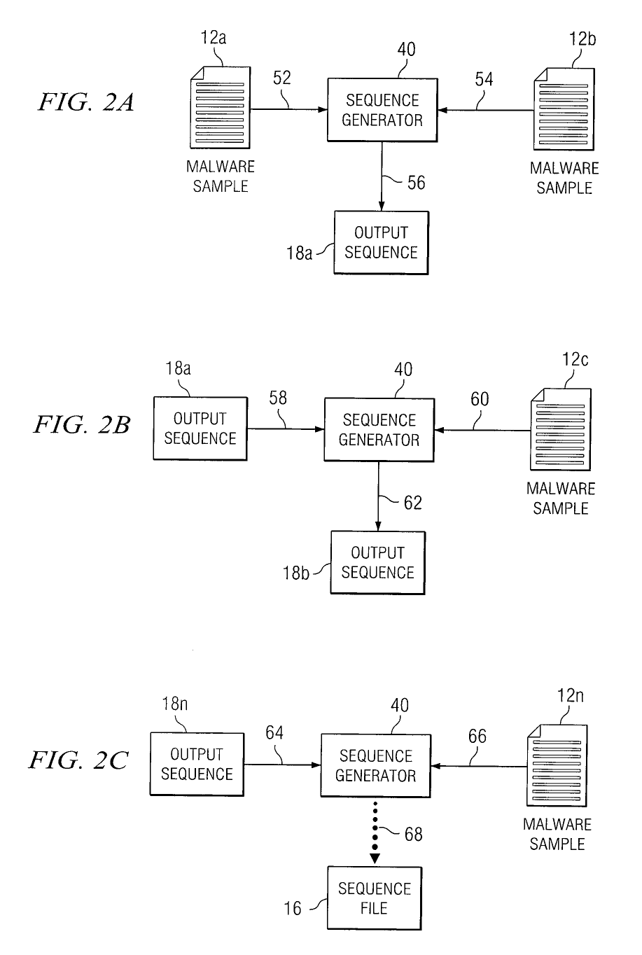

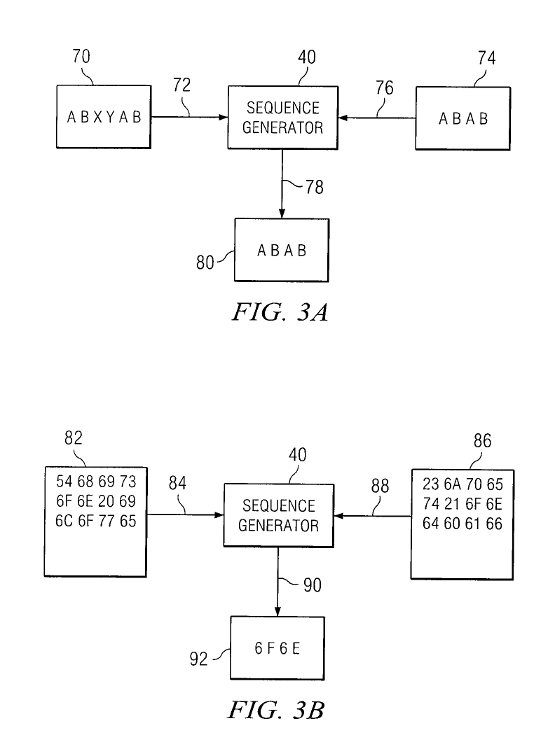

Input device 32 may refer to any suitable device operable to input, select, and/or manipulate various data and information. Input device 32 may include, for example, a keyboard, mouse, graphics tablet, joystick, light pen, microphone, scanner, or other suitable input device. Additional details of example embodiments of the disclosure are described in greater detail below in conjunction with portions of FIG. 2 and FIG. 3.

FIG. 2A is a block diagram illustrating sequence generator 40 of system 10 of FIG. 1 generating an output sequence 18a, according to one embodiment of the present disclosure. As shown in the illustrated embodiment, sequence generator 40 receives two input files, malware sample file 12a and malware sample file 12b. Sequence generator 40 may compare malware sample file 12a and malware sample file 12b to identify a first sequence. In particular embodiments, sequence generator 40 may identify the first sequence by identifying at least one longest common subsequence. Sequence generator 40 may generate at least a first output sequence 18a based on the first sequence. As described in more detail below with reference to FIG. 2B, sequence generator 40 may use output sequence 18a in the next comparison iteration.

FIG. 2B is a block diagram illustrating sequence generator 40 of system 10 of FIG. 1 generating another output sequence 18b, according to one embodiment of the present disclosure. As shown in the illustrated embodiment, sequence generator 40 receives output sequence 18a and malware sample file 12c. Sequence generator 40 may compare output sequence 18a and malware sample file 12c to identify a second sequence. In particular embodiments, sequence generator 40 may identify the second sequence by identifying at least one longest common subsequence. Sequence generator 40 may generate at least a second output sequence 18b based on the second sequence. As described in more detail below with reference to FIG. 2C, sequence generator 40 may iterate over malware samples files 12, comparing a file to the output of the previous comparison, and sequence generator 40 may generate a malware sequence file based on the iterations.

FIG. 2C is a block diagram illustrating sequence generator 40 of system 10 of FIG. 1 generating malware sequence file 16, according to one embodiment of the present disclosure. As shown in the illustrated embodiment, sequence generator 40 is in the “nth step” of generating malware sequence file 16 and receives output sequence 18n and malware sample file 12n. Sequence generator 40 may compare output sequence 18n and malware sample file 12n to identify a final sequence. In particular embodiments, sequence generator 40 may identify the final sequence by identifying at least one longest common subsequence. Sequence generator 40 may generate malware sequence file 16 based on the final sequence.

FIG. 3A is a block diagram illustrating sequence generator 40 of system 10 of FIG. 1 generating a sequence 80 based on a longest common subsequence, according to one embodiment of the present disclosure. As shown in the illustrated embodiment, sequence generator 40 receives two input files, malware sample file 70 and malware sample file 74. Malware sample file 70 includes a first string and malware sample file 74 includes a second string. The strings in malware sample file 70 and malware sample file 74 may include a string of bytes, a string of characters, or any other suitable string. Sequence generator 40 may compare malware sample file 70 and malware sample file 74 to identify a first sequence. Sequence generator 40 identifies the first sequence by identifying at least one longest common subsequence. In the embodiment, sequence generator 40 identifies the string “ABAB” as the longest common subsequence in malware sample file 70 and malware sample file 74. Sequence generator 40 generates sequence 80 based the longest common subsequence.

FIG. 3B is a block diagram illustrating sequence generator 40 of system 10 of FIG. 1 generating another sequence 92 based on a longest common subsequence, according to one embodiment of the present disclosure. As shown in the illustrated embodiment, sequence generator 40 receives two input files, malware sample file 82 and malware sample file 86. Malware sample file 82 and malware sample file 86 each include a string of hexadecimal characters. Sequence generator 40 may compare malware sample file 82 and malware sample file 86 to identify a first sequence. Sequence generator 40 identifies the first sequence by identifying at least one longest common subsequence. In the embodiment, sequence generator 40 identifies the string “6F 6E” as the longest common subsequence in malware sample file 82 and malware sample file 86. Sequence generator 40 generates sequence 92 based the longest common subsequence.

FIG. 4 is a flow diagram illustrating a method 100 for generating a malware sequence file, according to one embodiment of the present disclosure. The method begins at step 102 where files are received. Each of the files include at least one malware sample. A common sequence is identified in steps 104-110. For example, at least a first file of the files and a second file of the files are compared to identify a first sequence at step 104. At least a first output sequence based on the first sequence is generated at step 106. At least a third file of the files and the first output sequence are compared to identify at least a next sequence at step 108. At least a next output sequence based on the next sequence is generated at step 110. At step 112, it is determined whether the iterations are complete. If the iterations are not complete (e.g., there are more malware sample files to compare) the method returns to step 108 to identify the next common sequence. If the iterations are complete, at step 114 a malware sequence file for the files may be generated.

Thus, the method and system described herein improves current methods to generate a malware sequence file. For example, the malware sequence file may be generated by identifying longest common subsequences of malware sample files. By iteratively comparing sample malware files to identify the longest common subsequence, the system may efficiently generate the malware sequence file. The malware sequence file may be generic to identify entire families of malware.

Numerous other changes, substitutions, variations, alterations and modifications may be ascertained by those skilled in the art and it is intended that the present disclosure encompass all such changes, substitutions, variations, alterations and modifications as falling within the spirit and scope of the appended claims. Moreover, the present disclosure is not intended to be limited in any way by any statement in the specification that is not otherwise reflected in the claims.

What is claimed is:

1. A method, comprising:
generating a malware sequence file by identifying a common sequence among a plurality of files, wherein identifying a common sequence among the plurality of files comprises:
comparing at least a first file of the plurality of files and a second file of the plurality of files to identify a first output sequence; and
comparing at least a third file of the plurality of files and the first output sequence to identify at least a second output sequence.

2. The method of claim 1, wherein the first output sequence comprises a longest common subsequence.

3. The method of claim 1, wherein the second output sequence comprises a longest common subsequence.

4. The method of claim 1, wherein comparing at least a first file of the plurality of files and a second file of the plurality of files comprises comparing at least a first file of the plurality of files and a second file of the plurality of files to identify a longest common subsequence.

5. The method of claim 1, wherein comparing at least a third file of the plurality of files and the first output sequence comprises comparing at least a third file of the plurality of files and the first output sequence to identify a longest common subsequence.

6. The method of claim 1, wherein identifying a common sequence among the plurality of files further comprises comparing at least a fourth file of the plurality of files and the second output sequence to identify at least a third output sequence.

7. The method of claim 1, wherein identifying a common sequence among the plurality of files further comprises:
identifying a plurality of bytes indicative of zero in the plurality of files; and
removing the plurality of bytes.

8. A system, comprising:
a storage device; and
a processor, the processor operable to execute a program of instructions operable to:
generate a malware sequence file by identifying a common sequence among a plurality of files, wherein identifying a common sequence among the plurality of files comprises:
comparing at least a first file of the plurality of files and a second file of the plurality of files to identify a first output sequence; and
comparing at least a third file of the plurality of files and the first output sequence to identify at least a second output sequence.

9. The system of claim 8, wherein the first output sequence comprises a longest common subsequence.

10. The system of claim 8, wherein the second output sequence comprises a longest common subsequence.

11. The system of claim 8, wherein the program of instructions is further operable to compare at least a first file of the plurality of files and a second file of the plurality of files to identify a longest common subsequence.

12. The system of claim 8, wherein the program of instructions is further operable to compare at least a third file of the plurality of files and the first output sequence to identify a longest common subsequence.

13. The system of claim 8, wherein the program of instructions is further operable to compare at least a fourth file of the plurality of files and the second output sequence to identify at least a third output sequence.

14. The system of claim 8, wherein the program of instructions is further operable to:
identify a plurality of bytes indicative of zero in the plurality of files; and
remove the plurality of bytes.

15. Logic encoded in media, the logic being operable, when executed on a processor, to:
generate a malware sequence file by identifying a common sequence among a plurality of files, wherein identifying a common sequence among the plurality of files comprises:
comparing at least a first file of the plurality of files and a second file of the plurality of files to identify a first output sequence; and
comparing at least a third file of the plurality of files and the first output sequence to identify at least a second output sequence.

16. The logic of claim 15, wherein the first output sequence comprises a longest common subsequence.

17. The logic of claim 15, wherein the second output sequence comprises a longest common subsequence.

18. The logic of claim 15, wherein the logic is further operable to compare at least a first file of the plurality of files and a second file of the plurality of files to identify a longest common subsequence.

19. The logic of claim 15, wherein the logic is further operable to compare at least a third file of the plurality of files and the first output sequence to identify a longest common subsequence.

20. The logic of claim 15, wherein the logic is further operable to compare at least a fourth file of the plurality of files and the second output sequence to identify at least a third output sequence.
